(19) United States
(12) Patent Application Publication
(10) Pub. No.: US 2026/0148645 A1
(43) Pub. Date: May 28, 2026

(54) METHOD AND SYSTEM OF AIRCRAFT GROUND NAVIGATION

(71) Applicant: HONEYWELL INTERNATIONAL INC., Charlotte, NC (US)

(72) Inventors: Karthikeyan M, Madurai (IN); Srilakshmi Kurudi, Bangalore (IN); Gobinathan Baladhandapani, Madurai (IN); Pradeep Huncha, Bangalore (IN)

(73) Assignee: HONEYWELL INTERNATIONAL INC., Charlotte, NC (US)

(21) Appl. No.: 19/078,728

(22) Filed: Mar. 13, 2025

(30) Foreign Application Priority Data
Nov. 27, 2024 (IN) 202411092805

(51) Int. Cl. G08G 5/51; B64D 43/00; G07C 5/04

(52) U.S. Cl. CPC G08G 5/51; B64D 43/00; G07C 5/04

(57) ABSTRACT

In one implementation, a method includes determining, by at least one processor, a target destination at an airport airside and of an aircraft, and receiving at least one aircraft current operating context indicating a current state of the aircraft, a current environment around the aircraft, or both. The method also includes determining, by at least one processor, at least one ground navigation guidance procedure for the aircraft to move on the airport airside and that includes (a) looking up the aircraft current operating context in a catalog of predetermined historical operating contexts of aircraft moving on the airport airside to determine a match between the aircraft current operating context and one of the historical operating contexts, and (b) identifying at least one ground navigation guidance procedure of a matching one of the historical operating contexts. The method includes providing the identified procedures to at least one operator of the aircraft.

### CROSS REFERENCE TO RELATED APPLICATION

This application claims priority to India Provisional Patent Application No. 202411092805, filed Nov. 27, 2024, the entire content of which is incorporated by reference herein.

### TECHNICAL FIELD

The subject matter described herein generally relates to aircraft operations, and more particularly relates to aircraft ground navigation at airports.

### BACKGROUND

During aircraft and airport operations, reducing taxiing time can have a significant effect on both airport efficiency and airport capacity. Taxiway management systems are used to reduce the taxiing time and can provide pilots with better ground situational awareness and a ground movement plan before landing. It is desired, however, to provide a taxiway management system that takes better advantage of the variety of parameter data available to generate ground movement plans that improve aircraft ground navigation efficiency and performance while reducing taxiing durations.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one implementation, a method includes determining, by at least one processor, a target destination at an airport airside and of an aircraft, and receiving at least one aircraft current operating context indicating a current state of the aircraft, a current environment around the aircraft, or both. The method also includes determining, by at least one processor, at least one ground navigation guidance procedure for the aircraft to move on the airport airside and that includes (a) looking up the aircraft current operating context in a catalog of predetermined historical operating contexts of aircraft moving on the airport airside to determine a match between the aircraft current operating context and one of the historical operating contexts, and (b) identifying at least one ground navigation guidance procedure of a matching one of the historical operating contexts. The method includes providing the identified at least one ground navigation procedure to at least one operator of the aircraft.

In another implementation, a system includes memory, and processor circuitry forming at least one processor arranged to operate by determining a target destination at an airport airside and of an aircraft, and receiving at least one aircraft current operating context indicating a current state of the aircraft, a current environment around the aircraft, or both at the airport airside or while the aircraft is approaching the airport airside. The processor also operates by determining at least one ground navigation guidance procedure for the aircraft to move on the airport airside, including (a) looking up the aircraft current operating context in a catalog of predetermined historical operating contexts of aircraft moving on the airport airside to determine a match between the aircraft current operating context and one of the historical operating contexts, and (b) identifying at least one ground navigation procedure of a matching one of the historical operating contexts. The processor may operate by providing the identified at least one ground navigation procedure to at least one operator of the aircraft.

In yet another implementation, a non-transitory computer-readable medium includes instructions thereon that when executed by a computing device, cause the computing device to operate by: determining a target destination at an airport airside and of an aircraft, and receiving at least one aircraft current operating context indicating a current state of the aircraft, a current environment around the aircraft, or both at the airport airside or while the aircraft is approaching the airport airside. The computing device is also caused to operate by determining at least one ground navigation guidance procedure for the aircraft to move on the airport airside, includes (a) looking up the aircraft current operating context in a catalog of predetermined historical operating contexts of aircraft moving on the airport airside to determine a match between the aircraft current operating context and one of the historical operating contexts, and (b) identifying at least one ground navigation procedure of a matching one of the historical operating contexts. The computing device is also caused to operate by and providing the identified at least one ground navigation procedure to be displayed to at least one operator of the aircraft.

Furthermore, other desirable features and characteristics of the disclosed implementations will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic diagram of an example aircraft system according to at least one of the implementations disclosed herein;

FIG. 2 is a schematic diagram of an example ground navigation system according to at least one of the implementations disclosed herein;

FIG. 3 is a flow chart of an example method of ground navigation collecting historical data according to at least one of the implementations disclosed herein;

FIG. 4 is a schematic diagram of another part of the example ground navigation system of FIG. 2 according to at least one of the implementations disclosed herein;

FIG. 5 is a flow chart of another example method of ground navigation using historical data according to at least one of the implementations disclosed herein;

FIG. 6 is an image for a display device on an aircraft and of an overhead view of an airport airside annotated with ground navigation route guidance according to at least one of the implementations disclosed herein;

FIG. 7 is an image for a display device on an aircraft of another overhead view of an airport airside annotated with ground navigation guidance according to at least one of the implementations disclosed herein;

FIG. 8 is an image for a display device on an aircraft of an overhead, forward aircraft perspective view of another airport airside annotated to show ground navigation guidance according to at least one of the implementations disclosed herein;

FIG. 9 is a schematic diagram of an airport airside to explain ground navigation guidance for aircraft departing according to at least one of the implementations disclosed herein; and

FIG. 10 is a schematic diagram of an airport airside to explain ground navigation guidance for aircraft arriving according to at least one of the implementations disclosed herein.

### DETAILED DESCRIPTION

The following detailed description is merely on example and is not intended to limit the subject matter of the application and uses thereof. Furthermore, there is no intention to be bound by any expressed or implied theory presented in the preceding technical field, background, brief summary, brief description of drawings, or the following detailed description.

The disclosed method and system reduces surface delay and increases efficiency of ground navigation for an aircraft moving at the airside of an airport by customizing taxiing or movement instructions or procedures for a specific flight of a specific aircraft, the route (or clearance) provided, the airport, and other operational context for the aircraft being analyzed. This is accomplished by first having a ground navigation system generate a catalog or database of historical operating contexts and previously performed ground navigation guidance procedures (or parameters) associated with the individual historical operating contexts. Then during a runtime, the ground navigation system first receives a target destination of an aircraft at an airport airside prior to commencing ground navigation operations including movement on taxiways and runways. The system also obtains aircraft current operating contexts of operations at the airside that indicate the state and environment of the aircraft at the airside. The system then looks up the aircraft current operating context in the catalog to find a matching historical operating context. The guidance procedures of the matching historical operating context is adopted for the current situation of the aircraft at the airside. The guidance procedures are set to increase performance and reduce delay of the aircraft while taxiing. The resulting guidance procedures are provided to the aircraft and may be displayed on a display device to an operator or pilot of the aircraft for execution.

It should be noted herein, the area of an airport where aircraft can move on the ground is referred to as the airside of the airport, where the airside may include a movement area including taxiways and runways that is often controlled by an airport tower and/or an ATC, and a non-movement area including an apron (or ramp or tarmac) where the gates to the airport terminals are located and an aircraft may be permitted to move without airport tower and/or ATC instructions.

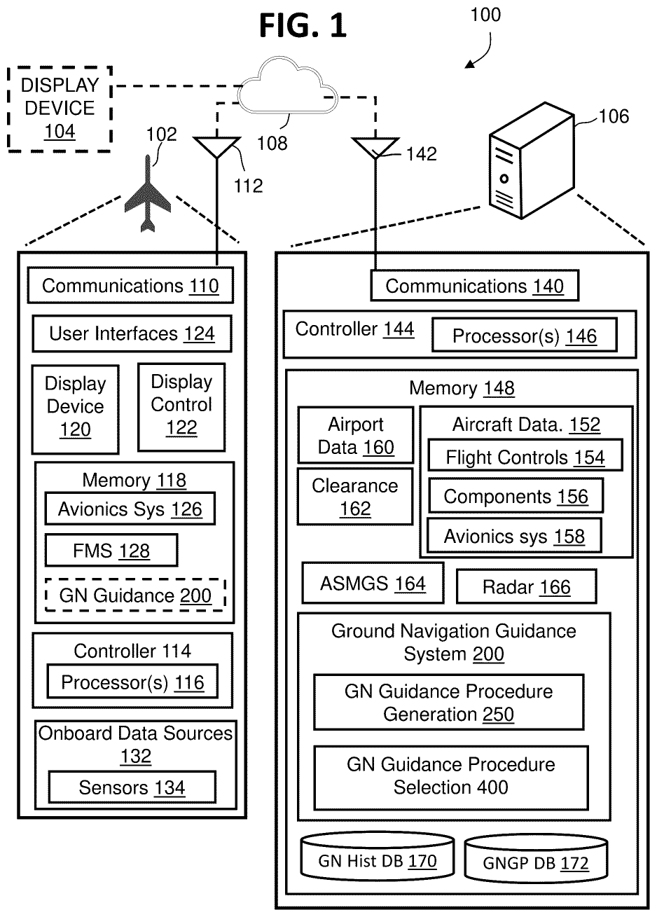

Referring to FIG. 1, an example aircraft system 100 is in accordance with the disclosed implementations. The aircraft system 100 includes at least one aircraft 102 and at least one remote system 106 that may be at a ground airline or vehicle control center or base, an airline flight operation (FlightOps) base, a dispatch team base, a maintenance base (or ground maintenance), and so forth. An optional separate mobile display device 104, such as a tablet or electronic flight bag (EFB) may be used as well as an alternative to using display device 120 as described below. The system 100 also may include a ground navigation guidance system 200 to increase efficiency and performance during taxiing as described herein. The aircraft 102 may include any number and type of aircraft including an airplane, helicopter, spacecraft, hovercraft, or the like, and is not particularly limited as long as the aircraft has the systems to be used with ground navigation guidance described herein.

The aircraft 102 may include a controller 114 operationally coupled to computer-readable storage media or memory 118, onboard data sources 132 including, for example, an array of sensors 134, and a communications system 110 including an antenna 112, which may wirelessly transmit data to and receive data from various external sources physically and/or geographically remote to the aircraft 102 such as the remote system 106. The aircraft 102 also may have one or more aircraft display devices 120, one or more display control units 122, one or more user interfaces 124 that use graphical user interfaces (GUIs) on the aircraft display device 120.

The memory 118 may hold or store a flight management system (FMS) 128, other avionics systems 126 described herein, and optionally a ground navigation guidance system 200 when it is desirable to provide the entire system 200, or portions thereof, on the aircraft 102 rather than solely on the mobile device 104 or at the remote system 106.

The remote system 106 may include a controller 144 operationally coupled to a remote computer-readable storage media or memory 148, a communications system 140 including an antenna 142, which may wirelessly transmit data to and receive data from various external sources physically and/or geographically remote to the remote system 106, such as to receive monitored data from the aircraft and transmit ground navigation (GN) procedures to the aircraft 102 or the mobile display device 104 as described herein.

Although schematically illustrated in FIG. 1 as a single unit, the individual elements and components of the system 100 can be implemented in a distributed manner utilizing any practical number of physically distinct and operatively interconnected pieces of hardware, equipment, nodes, or sites.

The term “controller,” as appearing herein, broadly encompasses those components used to perform or otherwise support the processing functionalities of the system 100. Accordingly, the controllers 114 and 144 can encompass or may be associated with circuitry forming any number of individual processors, computer-readable memories, databases, power supplies, storage devices, interface cards, and other standardized or customized components.

In various implementations, each of the controllers 114 and 144 include processor circuitry forming at least one processor 116 and 146 respectively, a communication bus (not shown), and a computer readable storage device or media. The processors 116 and 146 performs the computation and control functions of the controller 114 or 144. The processors 116 and 146, and the controllers 114 and 144 may form or be part of an avionic server or gateway server. The processors 116 and 146 can be any custom made or commercially available processor, a general purpose processor, a central processing unit (CPU), a graphics processing unit (GPU), a digital signal processor (DSP), an auxiliary processor among several processors associated with the controller 114 or 144, a semiconductor-based microprocessor (in the form of a microchip, chip set, system on a chip (SoC)), multiple processor cores, an application specific integrated circuit (ASIC), a field programmable gate array (FPGA) or other programmable logic device, discrete gate or transistor logic, discrete hardware components, or any combination thereof designed to perform the functions described herein. By one form, the controller 144 at the remote system 106 may have one or more processors 146 and other computing components on one or more servers, computers, laptops, desktops, and/or mobile devices such as tablets, smartphones, and so forth, and this may include cloud-based servers. In this regard, in addition the forms mentioned above, the remote system 106 may be realized as a remote information technology (IT) or control center, or otherwise as a maintenance or software update data center or a distributed network of remote control centers that reside at geographic locations that are separate and distinct from one or more edge computing systems that communicate directly with the controller 114 on the aircraft 102.

The memories 118 and 148 may include computer readable storage devices or media such as volatile and nonvolatile storage in read-only memory (ROM), random-access memory (RAM), flash memory, registers, and cache. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 114 or 144. The bus serves to transmit programs, data, status and other information or signals between the various components coupled to the controller 114 or 144. The bus can be any suitable physical or logical means of connecting computer systems and components. This includes, but is not limited to, direct hard-wired connections, fiber optics, infrared, and wireless bus technologies.

The executable instructions may include or establish one or more separate programs, each of which comprises an ordered listing of executable instructions for implementing logical functions. The instructions, when executed by the processor, perform logic, calculations, methods and/or algorithms, and generate data based on the logic, calculations, methods, and/or algorithms. Although only one of each of the controllers 114 and 144 are shown in FIG. 1, implementations of the system 100 can include any number of controllers 114 and 144 that communicate over any suitable communication medium or a combination of communication media and that cooperate to perform logic, calculations, methods, and/or algorithms, and generate data. In various implementations, the controllers 114 and 144 each includes or cooperates with at least one firmware and software program (generally, computer-readable instructions that embody an algorithm) for performing the various process tasks, calculations, and control/display functions described herein. During operation, each of the controllers 114 and 144 may be programmed with and execute at least one firmware or software program. This may include programs or applications stored in memory 148 as described below. Each of these units may have or use a database that is considered part of memory 148 or another memory.

Each of the controllers 114 and 144 may exchange data with one or more external sources to support operation of the system 100 in various implementations. In this case, bidirectional wireless data exchange may occur via the communications systems 110 and 140 over a communications network 108, such as a public or private network implemented in accordance with Transmission Control Protocol/Internet Protocol architectures or other conventional protocol standards. Encryption and mutual authentication techniques may be applied, as appropriate, to ensure data security.

In various implementations, each of the communications systems 110 and 140 are configured to support instantaneous (i.e., real time or current) communications between various systems. The communications systems 110 and 140 may each incorporate one or more transmitters, receivers, and the supporting communications hardware and software required for components of the system 100 to communicate as described herein. The network 108 used for communication may be a wireless gateway such as a data link management wireless (DLM-W) system that provides communication among systems within a cockpit and on an aircraft as well as transmission between the aircraft and the ground, Aircraft Communication Addressing and Reporting System (ACARS), which uses VHF, HF, or satellite communication (SATCOM) (whether via Wi-Fi or other network), VHF Data Link (VDL), High-Frequency Data Link (HFDL), and air-to-ground (ATG) systems. Other networks may be used when the aircraft 102 is on the ground such as cellular networks and ground Wi-Fi Networks while an aircraft is at a gate, taxiing, or at a remote location on the ground from a specific maintenance base. Any combination of these may be used. In various implementations, one or both the communications systems 110 and 140 may include additional communications not directly relied upon herein, such as bidirectional pilot-to-ATC (air traffic control) communications via a datalink, and any other suitable radio communication system that supports communications between the aircraft 102, the remote system 106, and various external source(s). The communications described herein also may apply to transmission to the display devices where suitable.

Each of the memories 118 and 148 can encompass any number and type of storage media suitable for storing computer-readable code or instructions, such as the applications or units mentioned above as well as other data generally supporting the operation of the system 100. As can be appreciated, each of the memories 118 and 148 may be part of their respective controller 114 or 144, separate, or both.

Returning to the aircraft 102, the onboard data sources 132 supply various types of data and/or measurements to the controller 114 so that the various avionics systems can generate relevant parameters, such as the state and condition of the aircraft 102 including the actual states of the flight components, equipment, thrusters, brakes, engines, and so forth on the aircraft. The parameters or flight operations described herein also may include any flight control settings including thrusters, brake controls, and so forth, as well as avionics value settings at each of the avionics systems, such as autopilot or real pilot input values (or default values) for various parameters such as speed, altitude, and so forth. Thus, the monitoring of avionic systems 126 such as the autopilot, navigation, and/or flight management systems (FMS) 128 to name a few examples may be monitoring real-time task execution. The onboard data sources 132 may use an array of sensors 134 of various types to detect the actual condition or position of the components and equipment on the aircraft. The details and operation of the types of sensors 134 are not needed for the understanding of the disclosed system and method.

In example implementations, the aircraft display device 120 is an electronic display capable of graphically displaying flight information or other data associated with operation of the aircraft 102. The aircraft display device 120 is communicatively coupled to, and controlled by, the display control unit 122 and/or processors 116. In this regard, the processors 116 and the display control unit 122 are cooperatively configured to display, render, or otherwise convey one or more graphical representations or images associated with operation of the aircraft 102 and relevant here, optionally can display GN guidance procedures or instructions on the aircraft display device 120, as described in greater detail below. Generally, aircraft display devices 120 visually convey a considerable amount of situational information for pilots. The displayed information is sourced from various databases, sensors, transponders, broadcasts, and FMS computations. The information is often organized in “information layers” (e.g., flight path information, Navigational Aids (NAVAID), airspace information, terrain information, weather information, traffic information, etc.). The various information layers are combined to provide a unified graphical display on the avionics display device 120.

In various implementations, the aircraft display device 120 may be a multifunction control display unit (MCDU), cockpit display device (CDU), primary flight display (PFD), primary engine display (PED), multi-function display (MFD), navigation display (ND) which may include a horizontal situational display (HSD) or horizontal situation indicator (HIS), a vertical display that displays vertical trajectories or profiles (or data of vertical trajectories), or any other suitable multifunction monitor or display suitable for displaying various symbols and information described herein. The aircraft display device 120 may be configured to support multi-colored or monochrome imagery, and the aircraft display device 120 may have a cathode ray tube (CRT) display, flat panel displays such as LCD (liquid crystal displays) and TFT (thin film transistor) displays or other LCD displays, a light emitting diode (LED) display, an organic light emitting diode (OLED) display, a heads-up display (HUD), a heads-down display (HDD), a plasma display, a projection display, a cathode ray tube (CRT) display, or the like. The display system may comprise display devices that provide three dimensional or two dimensional images and may provide synthetic vision imaging. Accordingly, each display device responds to a communication protocol that is either two-dimensional or three, and may support the overlay of text, alphanumeric information, or visual symbology.

The user interfaces 124 (or user input interface) are coupled to the processors 116, and the user interface 124 and the processors 116 are cooperatively configured to allow a user (e.g., a pilot, or crew member) to interact with the aircraft display device 120 and/or other elements of the system 100. Depending on the implementation, the user interface 124 may be a keypad, touchpad, keyboard, mouse, touch panel (or touchscreen), joystick, yoke, steering wheel, knob, line select key, or another suitable device adapted to receive input from a user. These interface devices are on or part of aircraft display device 120, or are wired or wirelessly connected to the aircraft display device 120 (or are optionally used with mobile display device 104). This may include any controller or input device for controlling the motion of the aircraft. In some implementations, the user interface 124 is, or includes, an audio input device, such as a microphone, audio transducer, audio sensor, or the like, accompanied with audio speech recognition and other software to input commands to an FMS 128 or to transcribe incoming audio messages, or other system or unit on the aircraft for example. In some implementations, the user interface 124 is a tactile user input device such as with touchpads or touch screens, stylus, pen, or the like.

The display control unit 122 has the hardware, firmware, processing logic and/or other components configured to control the display and/or rendering of one or more displays pertaining to operation of the aircraft 102 and/or avionics systems 126 and FMS 128 described below, and displays on the aircraft display device 120 (e.g., synthetic vision displays, navigational maps, HSDs, vertical profile (trajectory) displays, and the like). Also, the display control unit 122 may access or include one or more avionics databases (not shown) to generate image data for displays.

Still referring to FIG. 1, in one or more example implementations, the processors 116 on the aircraft 102 are coupled to the avionics systems including the FMS 128, the communications systems 110, as well as other avionics systems 126 such as a navigation unit or system, and one or more additional avionics units to support navigation, flight planning, and other aircraft control functions, as well as to provide real-time data and/or information regarding the operational status of the aircraft 102 to the processors 116. It should be noted that the system 100 and/or aircraft 102 will likely include numerous avionics systems for obtaining and/or providing real-time flight-related information that may be displayed on the aircraft display device 120 or otherwise provided to a user (e.g., a pilot). For example, practical implementations of the aircraft system 100 and/or aircraft 102 will likely include one or more of the following avionics systems 126 suitably configured to support operation of the aircraft 102: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag (EFB) and/or any other suitable avionics system. Each of these avionics systems or unit may include and/or use a database suitably configured to support operations of the avionics system 126 such as a terrain database, an obstacle database, an air restriction database, a navigational database, a geopolitical database, a terminal airspace database, a special use airspace database, and so forth for generating, rendering, and/or displaying navigational maps and/or other content on the aircraft display device 120 or to store and find other aircraft related data.

The FMS 128 may be configured to provide real-time navigational data and/or information regarding the operation of the aircraft 102 both to the pilot and to be transmitted to monitoring systems such as the avionics system unit 158 at the remote system 106. The FMS 128 and similar systems receive input from various sources including an ATC, the pilots, sensors, the navigation databases mentioned, and so forth, and uses the inputs to compute flight plans including horizontal and vertical trajectories. The output showing a flight plan is then displayed or otherwise provided to the aircrew, and this may include flight information including waypoints, altitudes, airspace limitations, airspeed settings, and so forth. This data may be used to set ground navigation procedures when relevant, such as an estimated time of arrival (ETA) or estimated time of takeoff (ETT) at a particular airport runway. The FMS 128 also may provide avionic display pages to be shown on the aircraft and that provide a moving map of the airport airside.

The avionic systems 126 also may have a separate weather system or unit that may have current weather conditions (or saved conditions at a certain time point) obtained from aircraft sensor data at sensor unit (not shown), wireless transmission from remote weather sources including the ATC or weather information servers, but also from the pilot or crew via FMS input pages displayed on the user interface 124. Such information may include wind direction and speed, precipitation, humidity, air pressure, and so forth. The weather or climate (or environmental) information that occurs during a flight may be transmitted directly to the avionics system data unit 158 at the remote system 106 as well as to the aircraft 102.

Turning again to the remote system 106, the memory 148 may have several data collecting units to be used to determine GN guidance procedures such as at least an aircraft data unit 152, an airport data unit 160, a clearance (or clearance-type) unit 162, an advanced surface movement guidance and control system (ASMGS) data unit 164, and a radar/automatic dependent surveillance broadcast (ADSB) data unit 166. The aircraft data unit 152 may have a flight controls unit 154 that collects data of current operation context related to the control settings on the aircraft 102, and a components unit 156 that collects the current operational context related to the actual state of the aircraft components such as the wheels, brakes, thrusters, engine, flaps, and so forth. The aircraft data unit 152 also may have an avionics systems unit 158 that receives FMS and avionics data indicating flight plans, the environment near the aircraft, and so forth. The aircraft data unit 152 also may retrieve or have the specifications for the type of aircraft as well as operational performance data and maintenance records and/or state for the specific aircraft.

The ground navigation guidance system 200 may use the collected data to generate GN guidance procedures (GNGPs) and may include a GN guidance procedure generation unit 250 that uses historical data to determine GNGPs or historical operational context and metrics that identify the correspondence or association between the historical operational context GN guidance procedures that were used in that context. A runtime GN guidance procedure selection unit 400 then generates GN guidance procedures during a runtime for a particular aircraft in a particular real or current operating context or state (where the aircraft current operating context also may be referred to as performance parameter data). This is accomplished by comparing the historical operating context to the aircraft current operating context. A GN history database 170 may hold the historical data and a GN guidance procedure (GNGP) database or catalog 172 may hold the metrics corresponding historical operational context to guidance procedures. The database 170 and catalog 172 together may be referred to as a taxiway or airside efficiency database.

With this arrangement, the present method and system determines procedures to increase aircraft efficiency during taxiway and airside operations. The procedures for taxiing efficiency of the aircraft is determined by using aircraft current performance parameters along with historical ground operations data that are retrieved from the taxiway efficiency database. By one example form, and whether before an aircraft lands at the airside or prepares to leave its gate for takeoff, the disclosed system displays GN guidance procedures that are the result of the efficiency determinations, provides better situational awareness of the airside, and suggests more efficient, faster, and/or successful procedures than without the system. This may include providing a pilot the ability to select among multiple alternative guidance procedures and confirm guidance procedures before execution of those procedures.

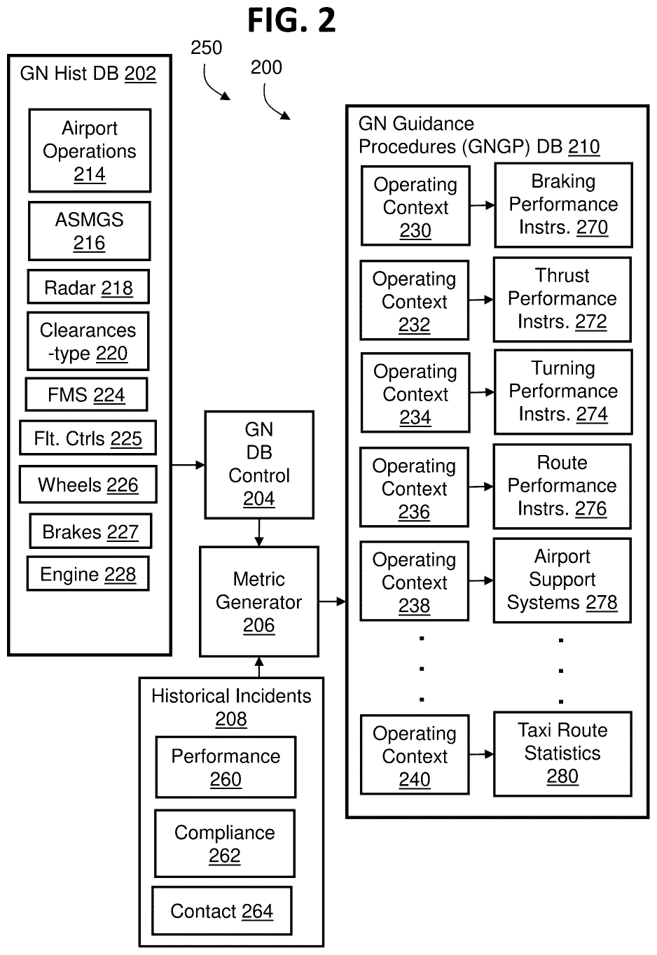

Referring to FIG. 2, the example GN guidance procedure generation unit 250 may have a GN historical database (or database unit) 202 (same as GN Hist DB 170), a GN DB control 204 that generates historical operating contexts, a historical incidents unit 208 that provides other historical incident data, and a metric generator 206 that determines or indicates guidance procedures that were previously performed for individual historical operating contexts. The historical operating contexts and the correspondences (or associations) with GN guidance procedures are listed in the GN guidance procedures (or parameters) database (or catalog) 210, including varying operating contexts 230 to 240 respectively indicating different types of performance instructions (or guidance procedures) 270 to 280.

In more detail, the GN Hist DB 202 provides and stores data that can be used to set historical operating contexts and performance procedures that should be performed in light of each of those contexts. It should be noted that both databases 202 and 210 are discussed herein to include controller units that collect data to be stored in the database such that the databases are not only storage devices, although any of the data collection units may be separate from the databases. In this example, the GN Hist DB 202 may have data collection units such as an airport operations data unit 214, an advanced surface movement guidance and control system (ASMGS) data unit 216, a radar and/or automatic dependent surveillance broadcast (ADSB) data unit 218, a clearances-type data unit 220, an FMS (or avionics systems) data unit 224, a flight controls data unit 225, aircraft components data units including a wheels unit 226, a brakes unit 227, and an engine unit 228. Each of these units may collect, manage, and store the indicated data and may be used to determine the historical operating contexts to be used to set the performance procedures.

For example, the airport operations data unit 214 may provide the layout of the airside including the labels for each taxiway, runway, and so forth, as well as taxiway operations used for a particular airport, the status or availability of the taxiways, taxiways with particular purposes such as with rapid exit taxiways, and so forth. This airport operation data may be obtained from a number of sources provided by the airport itself or other entities.

The example ASMGS data unit 216 is a ground guidance control system that may collect data related to tracking of aircraft positions and movement patterns on the airside, and potential and actual conflicts between aircraft ground routes and between other ground vehicles and aircraft. This may include instructions and monitoring of aircraft to maintain sufficient separation between the aircraft while performing ground navigation for all of the varying types of aircraft that may be on an airport airside. Thus, the ASMGS data unit 216 may use radar, sensors, and surveillance technologies to better ensure accurate situational airside awareness. This also may include data identifying the aircraft type, call sign, and other specifications to identify a specific aircraft.

The example radar/ADSB data unit 218 may collect and provide messaging that further indicates positions and movement of aircraft and can be used as another tool to monitor aircraft traffic and movement of all of the aircraft at an airside. This also may include data identifying the aircraft type, call sign, and other specifications to identify a specific aircraft.

The clearances-type data unit 220 refers to instructions, commands, and procedures that an aircraft should be following, or was instructed to follow. Thus, this first includes having the clearances-type unit 220 obtain and provide clearances from radio, datalink, or other communications units, and can be used to correspond to how an aircraft, and in turn pilot, executed the clearance. Likewise, this clearance-type unit 220 also may obtain and provide checklists, standard operating procedures (SOPs), procedures from aircraft manuals, or any other suitable instructions that can be compared to the actual actions of the pilot or aircraft.

The FMS data unit 224, may include data obtained from the FMS 128 or other avionics systems 126 and that may provide both target parameters of flight plans as well as actually executed parameters, including those in the air on approach and landing, and/or then those used during ground navigation. This may include parameters such as speed, fuel consumed or burnt, time points such as a target time to take-off and an actual time to take-off, as well as multi-function display (MFD) mapping which may provide a display page or image of taxiway views and aircraft positioning and motion on an airport airside.

Otherwise, the FMS data unit 224 also may collect airside data from any other system being used off-board at an airport or on-board an aircraft that monitors the airside aircraft and provides guidance, routing, airside mapping, and so forth to increase situational awareness at the airside and by pilots or off-board personnel such as at the air traffic towers of the airport or other control center.

The flight controls data unit 225 collects the data of the flight control settings used during previous ground navigation at or approaching the airside that can be compared to the actual positioning and motion of the aircraft as well as to the actual state of the aircraft components being controlled. This may include brake, thruster, tiller and rudder pedals (or other steering wheel or control) settings, fuel and engine controls, and so forth.

The remaining units of the GN Hist database 202 relate to components of the aircraft that are monitored so that actual states of the components can be factored to confirm alignment (or reveal misalignments) occurring among the actual state, the flight control settings, and clearances or instructions. For example, the wheels unit 226 may collect the monitored state of the wheels of an aircraft to also provide a historical operating context and guidance procedures (or parameters). Thus, the wheel unit 226 may collect and provide the wheel type, dimensions, and landing gear configuration for a type of aircraft and a specific aircraft as well as provide a state of the wheels at a certain time point corresponding to a time point of clearance instructions and flight control settings. This may include a wheel pressure, a landing gear state, wheel motion (spinning, speed, and direction or angle for turning wheel(s)), and so forth.

Likewise, the brakes data unit 227 may collect the specifications of the brakes for aircraft type and specific aircraft as well as the state of the brakes of an aircraft at certain time points (including durations), such as a percentage or level of brake force or psi, whether manual or auto-braking, to name a few examples. This data may become part of the historical operating context or as part of the guidance procedures.

Also, the engine unit 228 may collect the specifications of the engines for aircraft type and specific aircrafts as well as the state of the engines of an aircraft also monitored to provide a historical operating context and guidance procedures (or parameters).

The GN DB control unit 204 analyzes the historical data in the GN Hist DB 202 and forms historical operating contexts that are stored in the GN Hist DB 202 and/or the GNGP DB or catalog 210. The GN DB control unit 204 collects the data at a certain time point (or duration) to form a single historical operating context, and this may be repeated as long as historical data is being collected. The collected data may be arranged in predetermined context formats before providing the historical operating contexts to the catalog 210. Other details are provided below with process 300.

The historical incidents unit 208 collects data of incident contexts where resulting procedures were undesired or inadequate and should be avoided. This may involve a performance unit 260 that collects and records incident contexts where degraded performance occurred. For example, when excessive braking occurred, this may cause too much fuel consumption upon acceleration. In this case, the incident context may be compared to the historical operating contexts so that the historical contexts that caused this degradation will not be used as a template for future guidance (or at least a caution of wasteful fuel may be provided with a similar guidance procedure). This can be used for any of the aircraft components or operations being analyzed. It will be noted that aircraft performance can also vary due to other monitored factors such as weather or airport elevation. Thus, to collect these performance incidents, the system 200 may monitor the historical operating contexts for environmental or situational parameters that meet undesirable performance thresholds. Then, the historical incidents unit 208 may store the historical operating context as incident contexts accompanying undesirable procedures in a separate incident database or one of the databases mentioned herein.

Similarly, a compliance unit 262 monitors for incident contexts with a violation of a rule or regulation for example, such as extending too far into a runway when on a hold on a taxiway. These compliance incident contexts also are compared to the historical operating contexts to remove a historical operating context or provide a caution alert for a non-complying procedure.

Also, a contact unit 264 collects data of incidents when an aircraft undesirably contacts another aircraft or object, or has a near miss with another aircraft or object. This also may include runway or taxiway incursions as well as incidents with high risks of ground navigation contact, and so forth.

Thus, it will be noted that a single incident may have multiple incident categories. For example, a taxiway incursion may have both a contact and compliance issue. As another example, if an aircraft takes too wide a turn and comes very close to an obstacle, such as a signboard, then this may be both a compliance and contact incident as well as a performance incident if too much fuel was wasted on the turn. This can be analyzed due to the collected data of the flight controls and states of the steering, fuel, and positions of the aircraft in the historical operating contexts.

The metric generator unit 206 receives incident context data from the historical incidents unit 208 and the historical operating contexts from the GN DB control unit 204 to determine, if not already provided in the collected data, the guidance procedures (or parameters) associated with each or individual historical operating context. In each of these pairings, the guidance procedures were previously performed during or for the associated historical operating context.

The metric generator unit 206 then compares the historical operating contexts to the incident contexts to determine if there are any matches between the contexts. This may include finding one or more key context parameter matches, such as a certain aircraft type performing a same maneuver at a same location with the same or similar flight control settings. ‘Similarity’ here may be determined by using thresholds. These historical operating contexts found to be matching may be tagged to provide a caution alert when detected during a runtime, but otherwise may be eliminated or dropped so that the undesirable guidance procedures are not stored in the catalog 210 with the associated historical operating context. Those historical operating contexts passing this incident filter operation and are stored in the catalog 210 are deemed higher performance or more time efficient guidance procedures since they are not eliminated by the incident contexts that include degraded performance.

The metric generator unit 206 may handle and store such guidance procedures such as braking performance instructions 270, thrust performance instructions 272, turning performance instructions 274, route performance instructions 276, airport support systems 278, and taxi route statistics 280, although many more may be used here for any suitable guidance procedure. For flight controls such as for thrust, braking, and turning, the flight control setting, timing, and other triggering events for a pilot to monitor may be included for flight control guidance procedures. Otherwise, the route procedures 276 may have routes or maps for commonly used taxiways, alternative routes, taxiway status, congested areas, caution zones, and so forth.

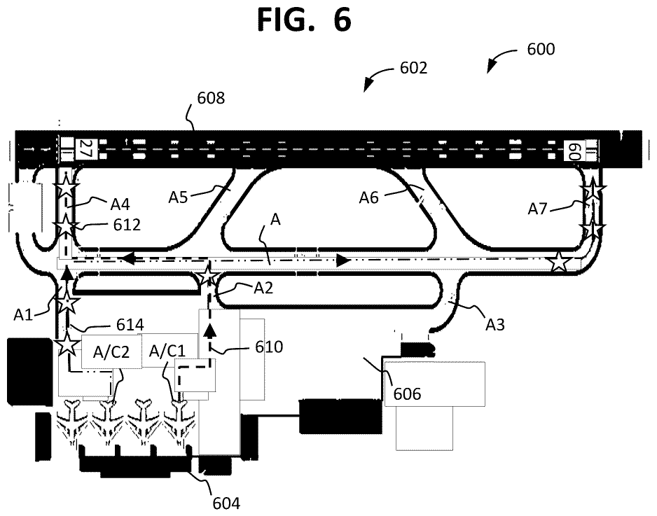

Referring to FIG. 6 as a routing example, an airport 600 has an airside 602 with a bi-directional runway 608 including runway (RWY) 27 from the left and RWY 09 from the right of the airside 602. Taxiway (TWY) A branches to taxiways A1, A2, and A3 to apron 606 amid terminal buildings 604, and branches A4, A5, A6, and A7 to runways 27 and 09. An aircraft A/C1 on apron 606 may receive guidance procedures (route performance instructions) to follow a route 610 and brake guidance procedures (performance instructions) 612 along route 610 shown in dashed line to, in order, A2, A, A4 and hold short to runway 27 and “upon clearance” to runway 27, where the stars indicate locations to brake according to the guidance procedures 612. Likewise, the aircraft A/C2 may have instructions to follow a route 614 in dash-dot-dot line, and including in order of A1, “hold short TWY A” (to permit A/C1 to pass) and “upon clearance” to A7, “hold short RWY 09” (to permit A/C1 to take off), and then to RWY 09. Again, the stars show brake locations to be performed, including to decelerate for turns.

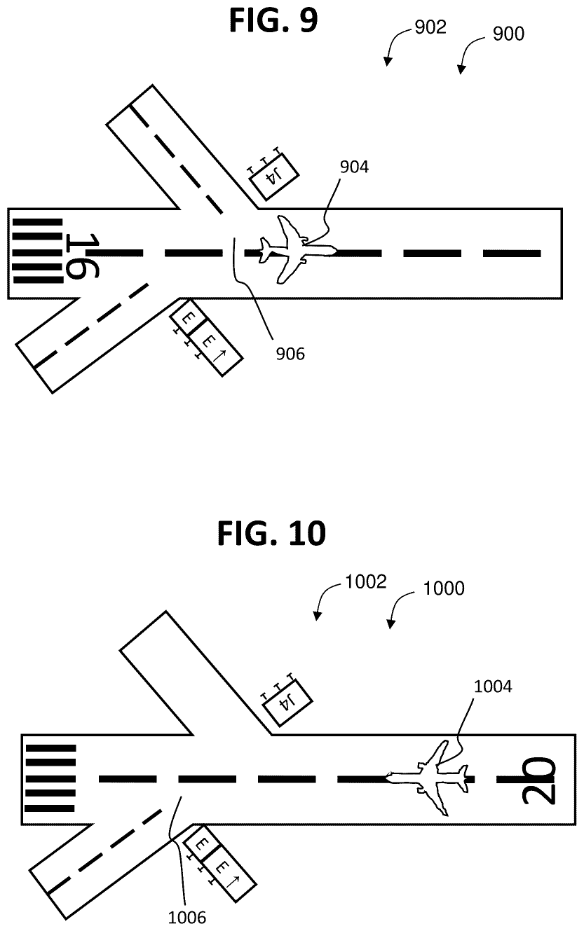

The airport support procedure may indicate type, timing, etc. of airport services such as lighting, push-back or follow-me vehicles, tugs, and so forth. The taxi route statistics procedures 280 may include statistics to assist a pilot to decide on a route or other parameters, such as a maximum speed to maintain to make a turn onto an upcoming taxiway with a certain distance from the aircraft. Many other examples are contemplated. One example is provided below with FIG. 9.

The historical operating contexts here 230 to 240 numbered evenly and paired or associated (or corresponding) GN guidance procedures 270 to 280 are stored in the GNGP database or catalog 210 (or 172 in FIG. 1). The GNGP DB or catalog 210 is then ready for run time use. Other details of the operation of the GN guidance procedure generation unit 250 is provided below with process 300.

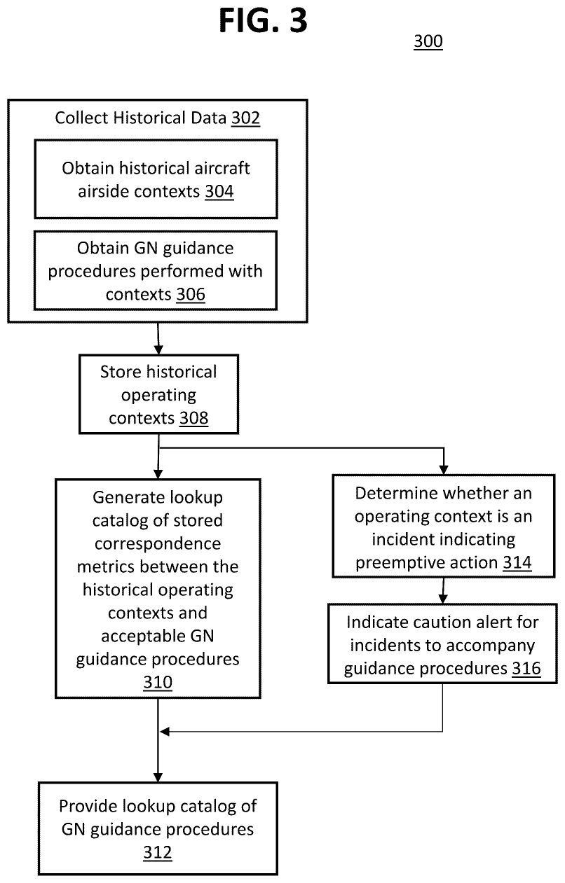

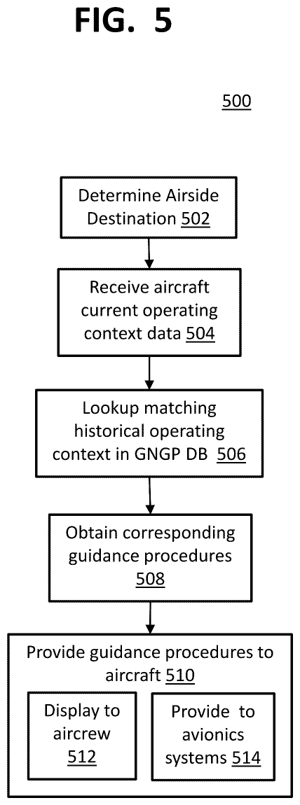

Referring to FIG. 3, a process 300 of generating a catalog of GN guidance procedures is described in accordance with at least one of the implementations herein. Below, the process 500 (FIG. 5) provides the GN guidance procedures during a runtime. The process 300 includes operations 302 to 312, generally numbered evenly. Systems, devices, modules, units, and images of any of FIGS. 1-2 and 4-10 may be referred to while describing process 300, where relevant.

Process 300 may include “collect historical data” 302, and this may be performed by the GN Hist DB 202. The collection may occur continuously (whether constant or at uniform intervals) or may occur during designated data collection time periods or durations. The data collection may be performed regardless of events at the airside or may be targeted to capture certain aircraft situations or motions such as with certain aircraft types at certain airside locations, landing aircraft, heavy traffic time periods, and so forth. By one example form, data collection may be triggered by motion sensing at a certain location at the airside.

By one example form, the historical data may be collected from many sources as described above, and may initially be organized by type of data and associations among the data (such as component and flight control data being tagged to a certain aircraft at a certain time and date). Thus, the historical data also may be placed in a temporal order by assigning time stamps to the collected data. That may include assigning time stamps of when data was received when that is relevant to determining guidance procedures, but otherwise is time stamped with a time as to when a relevant event occurred and data was collected, such as a position or motion of an aircraft, a position of a flight control, weather condition, airport operation conditions (such as a closed taxiway), receipt of clearances, and so forth.

Operation 300 may include “obtain historical aircraft airside contexts” 304, and from the GN DB control 204 that further organizes the collected data at a time stamp (or duration of time stamps) as one example into a single historical operating context for a single aircraft. This may have each such context in a predetermined uniform format for all historical operating contexts or a certain sub-set of the contexts with a similar situation for example. The format may be as a program file or metadata for example, or any other suitable format.

Operation 300 also may include “obtain GN guidance procedures performed with contexts” 306, and this may be performed by the metric generator 206. As mentioned above, the guidance procedures may be provided within the historical data as clearance-type data confirmed by (or supported by) flight control data and/or component setting data as described above. The result is the actual state of the components, and in turn, what should be the flight control settings to achieve those component states. This may be retrieved for specific instances in time to determine a single specific flight control setting or over a duration to obtain changing flight control settings over that duration.

Process 300 may include “store historical operating contexts” 308, where the historical operating contexts may be stored initially at the GN Hist DB 202, but are then indexed in a suitable order in the catalog 210 and in association with the guidance procedures.

Process 300 may include “generate lookup catalog of stored correspondence metrics between the historical operating contexts and acceptable GN guidance procedures” 310, and where the guidance procedures (or parameters) 270-280 for example are placed in the catalog 210 along with indicators or an association of the parameters with individual historical operating contexts 230 to 240. As mentioned above, many different guidance procedures may be saved whenever relevant to the airside movement of the aircraft. This may include having the guidance procedures stored in a same field or other database storage unit relative to the storage field location of the historical operating context, tagging, index number association, or any other suitable technique to associate the historical operating context with associated guidance procedures.

Process 300 may include “provide lookup catalog of GN guidance procedures” 312, where the catalog 210 is then provided at a computing device or location where the catalog is accessible to provide the guidance procedures upon receiving a current aircraft operating context. Thus, the catalog 210 may remain on a remote system 106, or may be provided on the aircraft 102 or another device, such as the mobile device 104, when such device has the capacity to store and operate the catalog 210. Many variations are contemplated.

Returning to the incidents, process 300 may include “determine whether an operating context is an incident indicating preemptive action” 314, and as described above with the units of the historical incident unit 208 to compare historical operating context with incident context to in turn determine historical operating contexts with undesirable guidance procedures.

Thereafter, process 300 may include “indicate caution alert for incidents to accompany guidance procedures” 316, when those historical contexts are still sufficient to be operated with caution. Otherwise, the historical operating context may be eliminated so that it is not stored in the catalog 210. The process 300 then returns to providing the catalog at operation 312.

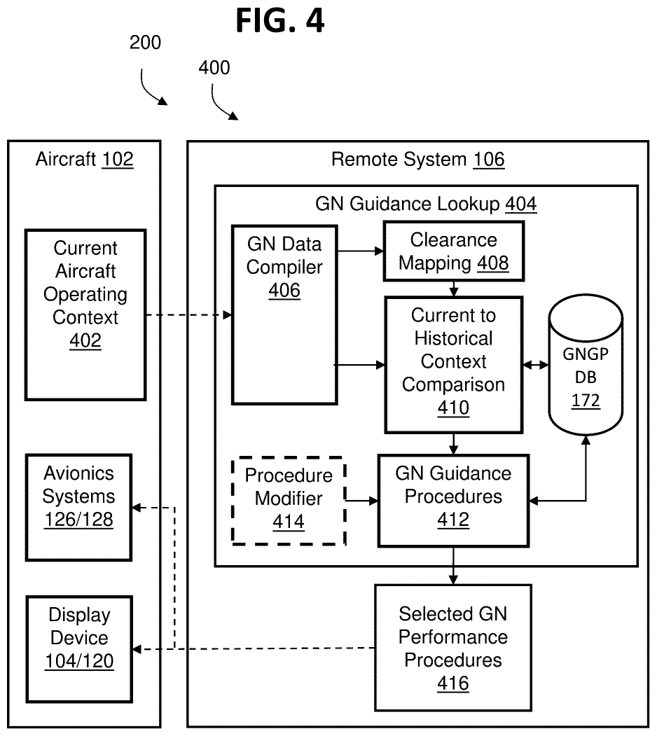

Referring to FIG. 4, the GN guidance procedure (or parameter) selection unit or system 400 of the ground navigation guidance system 200 may have a GN guidance lookup unit 404 that receives current aircraft operating context 402, and specifically received at a data compiler unit 406. The GN guidance lookup unit 404 also has a clearance mapping unit 408 and a current to historical context comparison unit 410 that accesses historical operating contexts from the GNGP catalog 210. The GN guidance lookup unit 404 also has a GN guidance procedures (or parameters) unit 412 that retrieves or selects the guidance parameters associated with a matching historical operating context. A procedure modifier unit 414 optionally may modify the retrieved guidance procedures when such procedures need updating or modifying due to other factors as explained below. The selected GN performance (or guidance) procedures 416 are then transmitted, or otherwise provided, to a display device 104 or 120 to be viewed by an operator of the aircraft, and/or to one or more avionics systems 126 or the FMS 128 for viewing and/or automatic implementation when such is provided. The details of the operation of the GN guidance procedure (or parameter) selection unit 400 are provided below with process 500.

Referring to FIG. 5, a process 500 of providing GN guidance procedures during a runtime is described in accordance with at least one of the implementations herein. The process 500 includes operations 502 to 512, generally numbered evenly. Systems, devices, modules, units, and images of any of FIGS. 1-4 and 6-10 may be referred to while describing process 500, where relevant.

As a preliminary matter, the runtime procedure selection unit or system 400 of the GN guidance system 200 may be activated automatically upon activation of one or more avionics systems or other system on the aircraft, but otherwise may be activated manually by a virtual or physical switch operated by the aircrew of a current aircraft (or ownship).

Process 500 may include “determine airside destination” 502, where an airside destination such as a runway, a terminal gate, a hanger, or other point (or entrance) on the airside may be provided through clearances or other sources. The clearances may be recorded, transcribed, and stored (or input by a pilot) to be part of the current operating context as well as for other uses by avionics systems for example.

Process 500 may include “receive aircraft current operating context data” 504. Here the current aircraft operating context 402 may be transmitted via many different networks 108 (FIG. 1) to the GN data compiler 406. This includes collecting the current aircraft operating context as with the historical operating context, and may include collecting data from avionics systems and/or any other sensor system on the aircraft that is recording the positions, motion, flight control settings, component states, any other current clearance-type messages, and so forth on the aircraft. This also may include context data additionally or alternatively from other sources such as with weather or other environmental conditions near the aircraft or airport. For aircraft landing this may include air traffic reports, and so forth. The aircraft operating context may be formatted as with the historical operating context, or in any suitable format that can be used to compare the historical and current operating contexts.

Process 500 may include “lookup matching historical operating context in GNGP DB” 506, where the current to historical context comparison unit 410 then performs the comparisons by looking up the current operating context in the list of historical operating contexts in the catalog 210. Typically, it may be sufficient that an aircraft is at a same location on the airport airside and about to perform the same maneuvers, often to the same destination. Other situations will call for more matches, such as weather related matches that may require the same type of brakes or type of aircraft for icy surfaces, for example. It will depend on the type and circumstances of the situation as to how many and which context parameters are to be matched. A match may be determined when two contexts have a context parameter that is sufficiently similar. This may include locations within a certain distance range, such as 10 feet as one example and depending on the situation, as well as flight control settings and aircraft components state within a certain range of each other that may be determined by experience. Each context parameter may have a similarity range when relevant to determine matches of context parameters.

Once a sufficient match is determined, process 500 may include “obtain corresponding guidance procedures” 508, where the GN guidance procedures unit 412 retrieves the guidance procedures associated with the matched historical operating context. The guidance procedures 270 to 280 are as described above.

Process 500 next may include “provide guidance procedures to aircraft” 510. This may include “display to aircrew” 512, which may include transmitting the selected GN performance procedures 416 to the avionics or other systems on the aircraft to display the procedures 416 on a display device 120 on the aircraft or a mobile display device 104 to show to the pilot for confirmation and execution when desired. The procedures 416 also may be displayed to the ATC or other entity controlling aircraft traffic at an airside including airport ground personnel on the airside. Also as mentioned, this may include providing a display of a separate listing (or an audio announcement) of the procedures that are not on an avionics display with graphics of the airside. Otherwise as another alternative, multiple alternative guidance procedures may be provided on at least one display screen, and the pilot may have the option to select which procedures to confirm and execute.

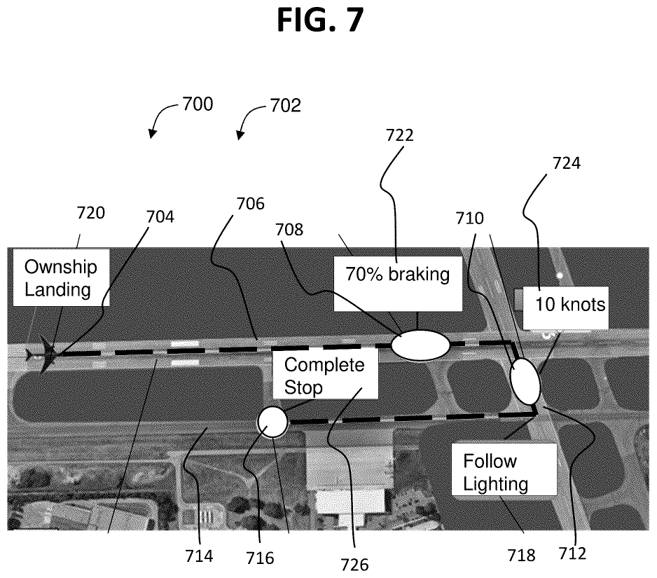

Referring to FIG. 7 for a display example, the procedures may show as pop-ups or windows in relevant locations on the avionics display and that are relevant to the actions to be performed in the guidance procedures. Thus for example, a display device may show an airport 700 has an airside map or image 702 with an ownship aircraft 704 that just landed on runway 706. A route line from the procedures may direct the aircraft 704 to generally follow lighting 726, and specifically to travel down runway 706, turn right onto a taxiway 712, and then turn right onto another taxiway 714. The guidance procedures also may have instructions to apply 70% brake at location 708, travel at 10 knots at location 710, and then stop at location 716. Each location has a location indicator here being a circle or oval on the map, and each window 720, 722, 724, 718, and 726 is strategically located on the airside map near where one of the guidance procedures is to be applied.

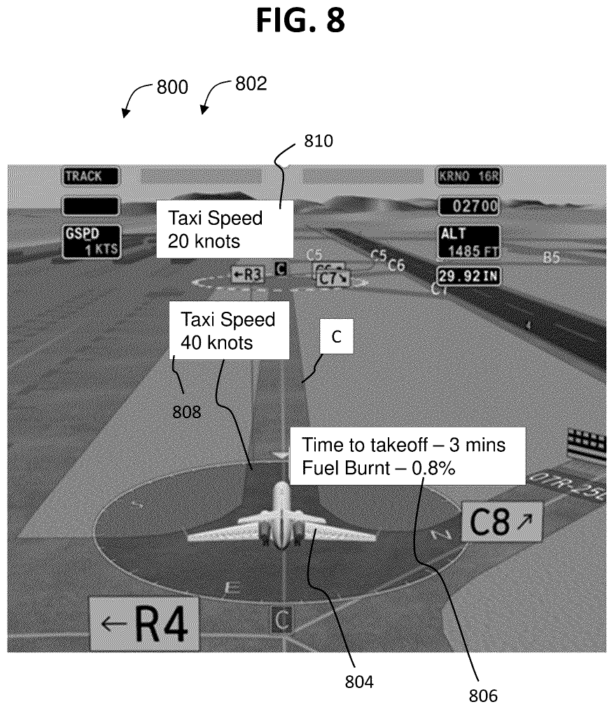

Referring to FIG. 8 for another display example, a forward perspective flight display of an airport 800 has an airside map or image 802 with an ownship aircraft 804 that is taxiing on taxiway (TWY) C. Statistics guidance procedures are shown in a window 806 and shows time to take off and fuel burnt, while a window 808 shows guidance procedures for speed (taxi speed 40 knots) along a straightaway of the TWY C, and then window 810 is father away to show a taxi speed of 20 knots before the aircraft is to turn on a TWY C5. Again, each window location is strategically located on the airside map near where one of the guidance procedures is to be applied, where relevant. Thus, note that the display may additionally indicate how efficient the operations are in terms of fuel and time and the placement of this window may or may not be relevant to a particular location.

As another example approach, operation 510 may include “provide to avionics systems” 514. Here, the procedures may also, or alternatively, be provided directly to the avionics or FMS systems on the aircraft for automatic execution. This may or may not include confirmation by the pilot depending on the type of guidance procedure is involved. This could include applying brakes, particularly when urgent to avoid contact between the aircraft and another object.

Referring to FIG. 9 for an example regarding statistics, a situation may arise at an airport 900 with an airside 902 where a target take off time is provided for an aircraft 904 entering a runway 16 from a taxiway J4 and through an intersection 906 to attempt an intersection take off. In this case, there may not be sufficient time to back the aircraft up to the close end of the runway to take off. The issue becomes whether there is a sufficient amount of runway distance from the intersection to a right far end of the runway to complete the takeoff.

In this case, the historically-based guidance procedures may be provided to the aircraft that include the option of traveling back to the end of the runway or for the intersection takeoff, and the success rate of the intersection takeoff and risk levels involved are communicated to the aircrew. In this example, the guidance procedures also may provide instructions that full power and higher flap settings are needed for the intersection takeoff. The pilot may have the option to choose either procedures.

Referring to FIG. 10 for another example of guidance procedures, an airport 1000 has an airside 1002 with an aircraft 1004 landing on runway 20 and plans to exit the runway on taxiway J4. In this example, and based on the historical data, the taxi exit on J4 is possible only with full brakes, airbrakes, and reverse thrust. Otherwise, the alternative is to use taxi exit E which has the flexibility of a higher taxi exit speed. The option of selecting the guidance procedures may be provided to the aircrew of the aircraft or may be automatically selected by the guidance system 200 or other system on the aircraft.

Those of skill in the art will appreciate that the various illustrative logical blocks, modules, circuits, and algorithm operations described in connection with the implementations disclosed herein may be implemented as electronic hardware, firmware, computer software, or combinations of both. Some of the implementations and implementations are described above in terms of functional and/or logical block components (or modules) and various processing operations. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and operations have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention. For example, an implementation of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that implementations described herein are merely exemplary implementations.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an implementation of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” or “units” in order to particularly emphasize their implementation independence. For example, functionality referred to herein as a module or unit may be implemented wholly, or partially, as a hardware circuit comprising custom VLSI circuits or gate arrays, off-the-shelf semiconductors such as logic chips, transistors, or other discrete components as described above. A module may also be implemented in programmable hardware devices such as field programmable gate arrays, programmable array logic, programmable logic devices, or the like. Modules or units may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process operations must be performed in a temporal or logical order according to such sequence unless it is specifically defined by the language of the claim. The process operations may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one example implementation has been presented in the foregoing detailed description of the invention, it should be appreciated that a vast number of variations exist. It should also be appreciated that the exemplary implementation or exemplary implementations are only examples, and are not intended to limit the scope, applicability, or configuration of the invention in any way. Rather, the foregoing detailed description will provide those skilled in the art with a convenient road map for implementing an exemplary implementation of the invention. It being understood that various changes may be made in the function and arrangement of elements described in an exemplary implementation without departing from the scope of the invention as set forth in the appended claims.

What is claimed is:

1. A method, comprising:
determining, by at least one processor, a target destination at an airport airside and of an aircraft;
receiving at least one aircraft current operating context indicating a current state of the aircraft, a current environment around the aircraft, or both;
determining, by at least one processor, at least one ground navigation guidance procedure for the aircraft to move on the airport airside, comprising:
looking up the aircraft current operating context in a catalog of predetermined historical operating contexts of aircraft moving on the airport airside to determine a match between the aircraft current operating context and one of the historical operating contexts, and
identifying at least one ground navigation guidance procedure of a matching one of the historical operating contexts; and
providing the identified at least one ground navigation procedure to at least one operator of the aircraft.

2. The method of claim 1, wherein the match is determined to occur when the current and historical operating contexts have at least a same current airside location and a same secondary factor including at least one of: a direction to move the aircraft from that same current airside location, a time to cross traffic, or a time to takeoff.

3. The method of claim 1, comprising generating the catalog of predetermined historical operating contexts comprising collecting historical data of at least one of:
airport operations data including map data of the airport airside and taxiway and runway data,
advanced surface movement guidance and control system (ASMGS) data including aircraft positions and traffic data for the airport airside,
radar-related data that indicates aircraft positions and movement on the airport airside,
clearance-related data indicating one or more clearance parameters provided to an aircraft,
avionics systems-related data used by an aircraft to set aircraft movement parameters,
flight control settings data indicating a setting of flight controls while an aircraft was located on the airport airside, and
aircraft component data indicating a state and limitations of components of an aircraft.

4. The method of claim 3, comprising organizing the collected historical data into historical operating contexts that each represent a previous instance or previous duration of aircraft motion on the airside.

5. The method of claim 4, comprising receiving the at least one ground navigation guidance procedures that were previously performed with individual ones of the historical operating contexts, and saving the at least one ground navigation guidance procedures and a correspondence indicator between the at least one ground navigation guidance procedures and a corresponding historical operating context in the catalog.

6. The method of claim 3, wherein the aircraft component data comprises at least one of: wheel data, brakes data, and engine data.

7. The method of claim 1, wherein the determining of at least one ground navigation procedure comprises removing at least one ground navigation procedures that result in a deemed incident with (1) degraded performance, (2) violation of a rule or regulation, (3) cause of an impact or near-miss with the aircraft, or any combination of (1), (2), and (3).

8. The method of claim 1, wherein the providing of the identified at least one ground navigation procedure comprises displaying the ground navigation guidance procedures on an avionics display in a cockpit of the aircraft.

9. The method of claim 1, wherein the at least one ground navigation procedures comprise aircraft parameters being at least one of: braking guidance, thrust guidance, turning guidance, taxiing route, and airport support system usage comprising services provided by an airport to assist with moving the aircraft.

10. A system, comprising:
memory; and
processor circuitry forming at least one processor communicatively coupled to the memory and being arranged to operate by;
determining a target destination at an airport airside and of an aircraft;
receiving at least one aircraft current operating context indicating a current state of the aircraft, a current environment around the aircraft, or both at the airport airside or while the aircraft is approaching the airport airside;
determining at least one ground navigation guidance procedure for the aircraft to move on the airport airside, comprising:
looking up the aircraft current operating context in a catalog of predetermined historical operating contexts of aircraft moving on the airport airside to determine a match between the aircraft current operating context and one of the historical operating contexts, and
identifying at least one ground navigation procedure of a matching one of the historical operating contexts; and
providing the identified at least one ground navigation procedure to at least one operator of the aircraft.

11. The system of claim 10, wherein the at least one ground navigation procedure comprises at least one flight control setting and a timing of the setting.

12. The system of claim 10, wherein the historical operating contexts vary depending at least on a type of aircraft, a specific aircraft, a current flight of the aircraft, which airport the aircraft is located, and current weather near the aircraft.

13. The system of claim 10, wherein the generating of the catalog comprises determining whether an incident match exists between at least one of the historical operating contexts and incident contexts, and wherein when the incident match exists, indicating a caution alert is to be provided to an operator of the aircraft when the match occurs between the current and historical operating contexts.

14. The system of claim 13, wherein the incident is associated with degraded performance of an aircraft deemed sufficiently significant to be labeled one of the incidents and may include an incident causing delay at the airport airside or too much fuel consumption at the airport airside.

15. The system of claim 13, wherein the incident is associated with an undesired actual contact or deemed near-miss contact between an aircraft and another object at the airside.

16. The system of claim 13, wherein the incidents are associated with a violation of a rule or regulation to be complied with by the aircraft.

17. A non-transitory computer-readable medium comprising instructions thereon that when executed by a computing device, cause the computing device to operate by:
determining a target destination at an airport airside and of an aircraft;
receiving at least one aircraft current operating context indicating a current state of the aircraft, a current environment around the aircraft, or both at the airport airside or while the aircraft is approaching the airport airside;
determining at least one ground navigation guidance procedure for the aircraft to move on the airport airside, comprising:
looking up the aircraft current operating context in a catalog of predetermined historical operating contexts of aircraft moving on the airport airside to determine a match between the aircraft current operating context and one of the historical operating contexts, and
identifying at least one ground navigation procedure of a matching one of the historical operating contexts; and
providing the identified at least one ground navigation procedure to be displayed to at least one operator of the aircraft.

18. The medium of claim 17, wherein the providing comprises a map of the airport airside on an avionics display and having a display of individual ones of the at least one ground navigation procedures each at a location on the map associated with the at least one ground navigation procedures.

19. The medium of claim 17, wherein the at least one ground navigation procedures includes informing at least one operator of the aircraft of movement statistics that indicate a level of risk of performing a movement on the airport airside.

20. The medium of claim 17, wherein the at least one ground navigation procedures comprises multiple alternative ground navigation procedures that provide an operator of the aircraft an option to select among the alternative ground navigation procedures.
